(19) United States
(12) Patent Application Publication
(10) Pub. No.: US 2013/0257900 A1
(43) Pub. Date: Oct. 3, 2013

(54) METHOD AND APPARATUS FOR STORING AUGMENTED REALITY POINT-OF-INTEREST INFORMATION

(71) Applicants: Hrishikesh Brahmakal, Espoo (FI); Janne Pekko Kaasalainen, Espoo (FI)

(72) Inventors: Hrishikesh Brahmakal, Espoo (FI); Janne Pekko Kaasalainen, Espoo (FI)

(73) Assignee: Nokia Corporation, Espoo (FI)

(21) Appl. No.: 13/436,061

(22) Filed: Mar. 30, 2012

(51) Int. Cl. G09G 5/00

(52) U.S. Cl. 345/619

(57) ABSTRACT

An approach is provided for storing and accessing point of interest information depicted in augmented and/or mixed reality mobile applications. A notification platform causes, at least in part, a rendering of a user interface depicting a virtual environment comprising one or more notifications associated with one or more points of interest. The notification platform determines one or more interactions with the user interface, the virtual environment, the one or more notification, or a combination thereof. The notification platform processes and/or facilitates a processing of the one or more interactions to cause, at least in part, a storage of the one or more notifications, one or more images, one or more videos, or a combination thereof.

### BACKGROUND

Service providers and device manufacturers (e.g., wireless, cellular, etc.) appear continually challenged to deliver value and convenience to consumers by, for example, providing compelling network services. One area of interest has been the development of augmented and/or mixed reality applications (e.g., mapping and/or navigation applications) for mobile devices (e.g., mobile phones and/or tablets) that feature interactive content and information associated with points of interest (POIs) in a particular location (e.g., contact information, hours of operation, customer reviews, etc.). Companies (e.g., JUNAIO and VALPAK) seem like they are also beginning to develop mobile applications that incorporate geo-targeted coupons in order to promote local businesses. However, current applications seem to lack the ability to intuitively store the point of interest information so that users can later review and possibly use the information at a more convenient time and/or location (e.g., when they are not driving, walking through a crowded shopping mall, etc.). Accordingly, service providers and devices manufacturers face significant technical challenges in providing a service that allows users to intuitively store and access point of interest information depicted in augmented and/or mixed reality mobile applications.

### SOME EXAMPLE EMBODIMENTS

Therefore, there is a need for an approach for storing and accessing point of interest information depicted in augmented and/or mixed reality mobile applications.

According to one embodiment, a method comprises causing, at least in part, a rendering of a user interface depicting a virtual environment comprising one or more notifications associated with one or more points of interest. The method also comprises determining one or more interactions with the user interface, the virtual environment, the one or more notification, or a combination thereof. The method further comprises processing and/or facilitating a processing of the one or more interactions to cause, at least in part, a storage of the one or more notifications, one or more images, one or more videos, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a rendering of a user interface depicting a virtual environment comprising one or more notifications associated with one or more points of interest. The apparatus is also caused to determine one or more interactions with the user interface, the virtual environment, the one or more notification, or a combination thereof. The apparatus is further caused to facilitate a processing of the one or more interactions to cause, at least in part, a storage of the one or more notifications, one or more images, one or more videos, or a combination thereof.

According to another embodiment, a computer-readable storage medium carries one or more sequences of one or more instructions which, when executed by one or more processors, cause, at least in part, an apparatus to cause, at least in part, a rendering of a user interface depicting a virtual environment comprising one or more notifications associated with one or more points of interest. The apparatus is also caused to determine one or more interactions with the user interface, the virtual environment, the one or more notification, or a combination thereof. The apparatus is further caused to facilitate a processing of the one or more interactions to cause, at least in part, a storage of the one or more notifications, one or more images, one or more videos, or a combination thereof.

According to another embodiment, an apparatus comprises means for causing, at least in part, a rendering of a user interface depicting a virtual environment comprising one or more notifications associated with one or more points of interest. The apparatus also comprises means for determining one or more interactions with the user interface, the virtual environment, the one or more notification, or a combination thereof. The apparatus further comprises means for processing and/or facilitating a processing of the one or more interactions to cause, at least in part, a storage of the one or more notifications, one or more images, one or more videos, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of storing and accessing point of interest information depicted in augmented and/or mixed reality mobile applications, according to one embodiment;

FIG. 2 is a diagram of the components of a notification platform, according to one embodiment;

FIGS. 3 and 4 are flowcharts of processes for storing and accessing point of interest information depicted in augmented and/or mixed reality mobile applications, according to one embodiment;

FIGS. 5 through 6B are diagrams of user interfaces utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for storing and accessing point of interest information depicted in augmented and/or mixed reality mobile applications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

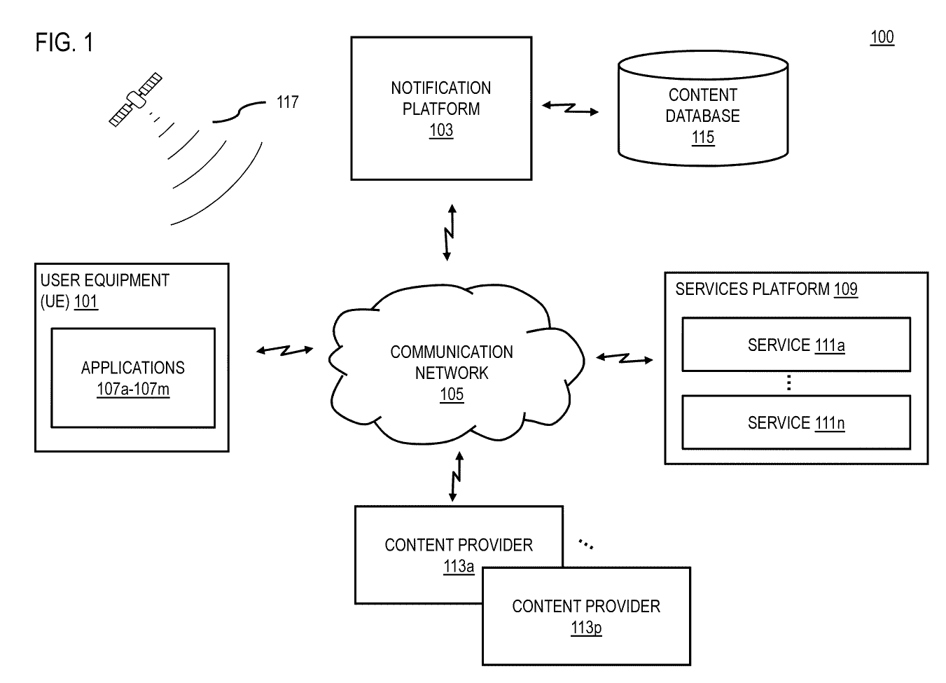

FIG. 1 is a diagram of a system capable of storing and accessing point of interest information depicted in augmented and/or mixed reality mobile applications, according to one embodiment. Augmented and/or mixed reality applications (e.g., mapping and/or navigation applications) for mobile devices (e.g., mobile phones and/or tablets) are increasingly featuring interactive content and information associated with various POIs in a particular location. Companies seem like they are also beginning to develop mobile applications incorporating geo-targeted coupons in on order to promote local businesses. However, current applications seem to lack the ability to intuitively store the information (e.g., a coupon) so that the users can review and possibly use the information at a more convenient time and/or location (e.g., when they are not driving, walking through a crowded shopping mall, etc.). By way of example, an end user may be driving to work and while he or she waits at a stoplight, a navigation application running on a mobile device (e.g., a mobile phone) presents one or more notifications to the user that there are some interesting coupons/offers available at the nearby shopping mall (e.g., as an overlay over the mapping information). However, the driver does not have the time to try and save the coupons/offers before the stoplight changes and therefore is unable to easily take advantage of the one or more coupons/offers.

To address this problem, a system 100 of FIG. 1 introduces the capability of storing and accessing point of interest information depicted in augmented and/or mixed reality mobile applications. More specifically, the system 100 causes a rendering of a user interface on a mobile device (e.g., a mobile phone or tablet) depicting a virtual environment comprising one or more notifications (e.g., one or more coupons) associated with one or more proximate POIs (e.g., a restaurant, a clothing store, a coffee shop, etc.). In particular, the virtual environment represents a real-world environment and is generated by or is associated with one or more augmented and/or mixed reality applications (e.g., Nokia Drive), one or more point and find technologies (e.g., Nokia City Lens), or a combination thereof. Moreover, the one or more notifications include one or more coupons (e.g., 20% off clothing, 2 for 1 coffees, etc.), one or more POI labels (e.g., MTR, Sushi Corner, Pizza Hut, etc.), geo-tagged content (e.g., Piazza del Campo), or a combination thereof. By way of example, an end user may be driving to work one day and while waiting for a signal change, an augmented and/or mixed reality mobile application (e.g., a navigation application) may notify the end user that some interesting coupons or offers are available at a nearby shopping plaza. In another example use case, the end user may see a nice restaurant while driving, but is uncertain of the restaurant's name or his or her location.

In one embodiment, the system 100 first determines location information associated with the one or more proximate POIs (e.g., a clothing shop, a coffee shop, a restaurant, etc.) depicted in the virtual environment using one or more location-based technologies associated with the mobile device (e.g., global positioning system (GPS) receivers, cellular triangulation, assisted-GPS (A-GPS), etc.). It is also contemplated that the one or more augmented and/or mixed reality applications used to render the virtual environment may already contain the geo-coordinates for the one or more POIs. The system 100 then processes the one or more notifications to determine metadata (e.g., coupon details, store information, customer reviews, etc.) associated with the one or more notifications. Further, the system 100 processes the metadata to determine specific temporal information (e.g., the date of expiration) associated with the one or more coupons. By way of example, one or more coupons associated with a point of interest may appear in an augmented and/or mixed reality application for only one week, however, the metadata associated with the coupon states that the offer will be valid for another two weeks after the coupon is no longer visible in the application. Therefore, the system 100 can determine that the one or more coupons may still have value to an end user even after the coupons are no longer visible in an augmented and/or mixed reality application. In addition, the system 100 also associates the location information (e.g., geo-coordinates) with the one or more notifications, the metadata, or a combination thereof that are not already geo-coded in order to enable a more accurate rendering of the virtual environment, the one or more notifications, or a combination thereof in the user interface of the mobile device.

The system 100 next determines one or more interactions with the user interface, the virtual environment, the one or more notifications, or a combination thereof. By way of example, the one or more interactions may include an end user clicking the photo capture button of his or her mobile device, selecting a “save” button associated with an augmented and/or mixed reality application, tapping the one or more notifications, or a combination thereof. The system 100 then causes, at least in part, a capture of one or more images (e.g., a shopping plaza including a clothing store, a coffee shop, a restaurant, etc.), one or more videos (e.g., a video of the drive to work), or a combination thereof associated with the virtual environment, the one or more notifications, or a combination thereof based, at least in part, on the one or more interactions. It is contemplated that in certain embodiments, the system 100 enables one or more interactions with one or more notifications (e.g., one or more coupons) to simply generate additional information or details associated with the one or more notifications (e.g., metadata) before actually storing the one or more notifications in the system 100 for later review.

In one embodiment, the system 100 then processes and/or facilitates a processing of the one or more interactions to cause, at least in part, a storage of the one or more notifications, the one or more images, the one or more videos, or a combination thereof on the mobile device rendering the virtual environment (e.g., in a wallet application). In another embodiment, the system 100 may also store the point of interest information on one or more remote servers (e.g., based on cloud storage technologies) that the one or more mobile devices, one or more users of the mobile devices, or a combination thereof may access with one or more credentials (e.g., usernames and passwords). As a result, the system 100 enables an end user to review and potentially use the point of interest information at a more convenient time (e.g., when the user is not driving, walking through a crowded shopping mall, etc.). Further, in one embodiment, the system 100 stores the point of interest information based, at least in part, on the temporal information associated with the one or more notifications, the metadata, or a combination thereof. As previously discussed, one or more coupons (e.g., 20% off clothing, 2 for 1 coffees, etc.) may be visibly associated with one or more points of interest for a week, however, the metadata associated with the coupons indicates that the coupons are valid for another two weeks after the coupons are no longer visible. Therefore, the system 100 would store the one or more coupons for their entire period of validation and then potentially overwrite the data in order to maximize computational resources. In one example use case, the system 100 would also continue to store the POI labels (e.g., a restaurant name and location) as long as the information was determined to be valuable given a particular context (e.g., vacation-based POIs may only be stored during the duration of the vacation).

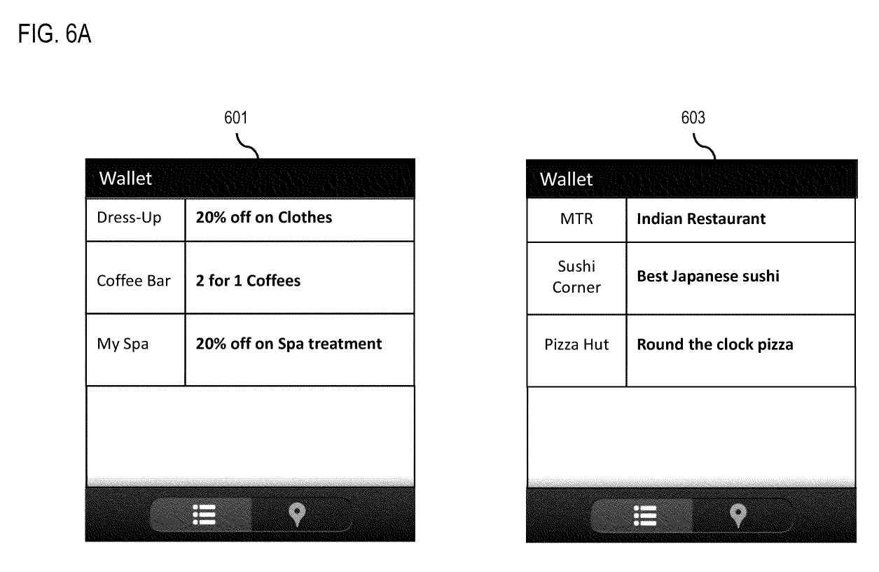

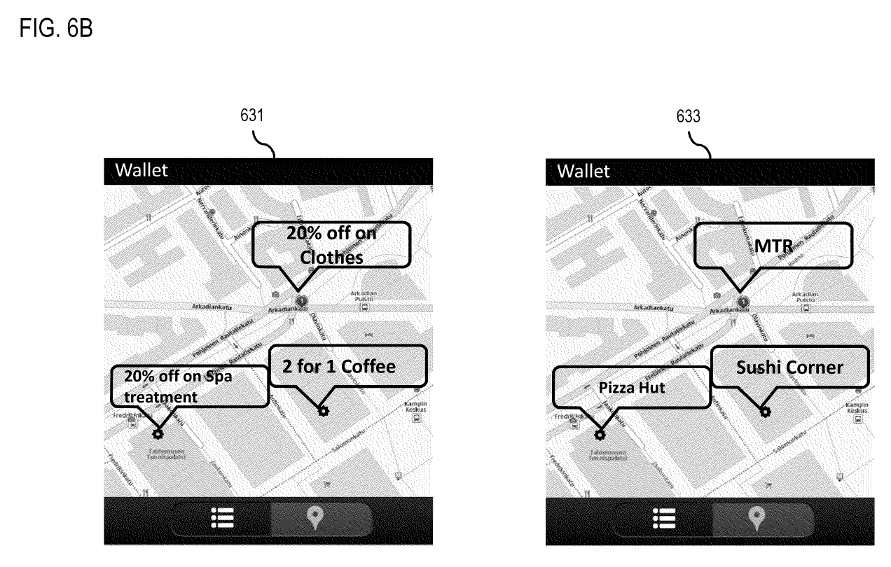

In one embodiment, once the one or more notifications are stored on a mobile device, one or more remote servers, or a combination thereof, the system 100 can cause at least one other rendering or view of the one or more notifications, the metadata, the location information, or a combination thereof in the user interface of a mobile device. More specifically, the system 100 can render the point of interest information as part of one or more lists, one or more maps, or a combination thereof (e.g., based on one or more user preferences). Further, the system 100 determines the one or more applicable maps based, at least in part, on the location information associated with the one or more points of interest, the one or more notifications, or a combination thereof. By way of example, the system 100 may render a list view in the user interface of a mobile device identifying the name of the point of interest in one column (e.g., Coffee Bar) and the details of the associated coupon in an adjacent column (e.g., 2 for 1 coffees). In another example use case, the system 100 may render a list view of the POIs in one column (e.g., MTR) and the details about the POI in the adjacent column (e.g., Indian Restaurant). Illustrative examples of the list view and map view user interfaces are depicted in FIGS. 6A and 6B, respectively.

As shown in FIG. 1, the system 100 comprises a user equipment (UE) 101 (e.g., a mobile phone or tablet) having connectivity to a notification platform 103 via a communication network 105. It is contemplated that the notification platform 103 may exist in whole or in part within the UE 101, or independently. Further, the UE 101 may include or be associated with one or more applications 107a-107m (e.g., augmented and/or mixed reality applications, mapping or navigation applications, point and find applications, etc.) (also collectively referred to as applications 107). The system 100 also includes a services platform 109 that provides one or more services 111a-111n (also collectively referred to as services 111) to the components of the system 100. The services 111 may include a wide variety of services such as content provisioning services for the applications 107. By way of example, the services 111 may provision to the applications 107 one or more coupons, one or more POI labels, geo-tagged content, or a combination thereof associated with various POIs. The services 111 may also include navigation services, mapping services, social networking services (e.g., a friend's review of a restaurant), location-based services, etc. Further, the services 111 may also include one or more interactive services. By way of example, it is contemplated that a service 111 may enable users to travel (e.g., by car or foot) around a shopping mall or plaza in order to collect coupons or offers associated with various POIs in that location. The UE 101 and the services platform 109 also have connectivity to one or more content providers 113a-113p (also collectively referred to as content providers 113). The content providers may provide location-based content to the components of the system 100 (e.g., building models, terrain mesh, panoramic images, etc.) that can be used by or in association with the applications 107.

In one embodiment, the notification platform 103 may be associated with a content database 115. The content database 115 may include one or more notifications, one or more images, one or more videos, or a combination thereof associated with various points of interest. The content database 115 may also include one or more maps or mapping information associated with points of interest in a particular area. Further, the content database 115 may exist in whole or in part within the notification platform 103, or independently.

In certain embodiments, one or more applications 107 may utilize location-based technologies (e.g., GPS, cellular triangulation, A-GPS, etc.) to make a request to one or more services 111 and/or one or more content providers 113 for location-based data (e.g., maps, one or more notifications, POI labels, geo-tagged content, etc.) based on a position relative to the UE 101. For example, a UE 101 may include a GPS receiver to obtain geographic coordinates from satellites 117 to determine its current location.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the notification platform 103 causes a rendering of a user interface on the UE 101 (e.g., a mobile phone or tablet) depicting a virtual environment comprising one or more notifications (e.g., one or more coupons) associated with one or more proximate POIs (e.g., a restaurant, a clothing store, a coffee shop, etc.). More specifically, the virtual environment represents a real-world environment and is generated by or is associated with the applications 107 (e.g., an augmented and/or mixed reality application). Moreover, the one or more notifications include one or more coupons (e.g., 20% of clothing, 2 for 1 coffees, etc.), one or more POI labels (e.g., MTR, Sushi Corner, Pizza Hut, etc.), geo-tagged content (e.g., Piazza del Campo), or a combination thereof.

In one embodiment, the notification platform 103 first determines location information associated with one or more proximate POIs (e.g., a clothing shop, a coffee shop, etc.) depicted in an application 107 using one or more location-based technologies associated with the mobile device (e.g., GPS). It is also contemplated that the application 107 used to render the virtual environment (e.g., an augmented and/or mixed reality application) may already contain the geo-coordinates for the one or more proximate POIs. The notification platform 103 then processes the one or more notifications to determine metadata associated with the one or more notifications (e.g., coupon details, store information, customer reviews, etc.). Further the notification platform 103 processes the metadata to determine specific temporal information (e.g., the date of expiration) associated with the one or more coupons. As previously discussed, one or more coupons may be valid and therefore potentially useful to an end user after they are no longer visible using the application 107 (e.g., an augmented and/or mixed reality application). In one embodiment, the notification platform 103 also associates the location information (e.g., geo-coordinates) with the one or more notifications, the metadata, or a combination thereof in order to enable a more accurate rendering of the virtual environment, the one or more notifications, or a combination thereof in the user interface of the UE 101.

In one embodiment, the notification platform 103 next determines one or more interactions with the user interface, the virtual environment, the one or more notifications, or a combination thereof depicted on the UE 101. By way of example, the one or more interactions may include an end user clicking the photo capture button of the UE 101, selecting a “save” button associated with an application 107, tapping the one or more notifications, or a combination thereof. The notification platform 103 then causes, at least in part, a capture of one or more images (e.g., an image of a shopping plaza), one or more videos (e.g., a video of the drive to work), or a combination thereof associated with the virtual environment, the one or more notifications, or a combination thereof based on the one or more interactions.

In one embodiment, the notification platform 103 then processes and/or facilitates a processing of the one or more interactions to cause, at least in part, a storage of the one or more notifications, the one or more images, the one or more videos, or a combination thereof on the UE 101 (e.g., in a wallet application). In another embodiment, the notification platform 103 may also store the point of interest information within the content database 115. As a result, the notification platform 103 enables an end user to review and potentially use the various point of interest information at a more convenient time (e.g., when the user is not driving, walking through a crowded shopping mall, etc.). Further, in one embodiment, the notification platform 103 stores the POI information based, at least in part, on the temporal information associated with the one or more notifications, the metadata, or a combination thereof. In this example use case, the notification platform 103 would store the one or more coupons for their entire period of validation and then potentially overwrite the data in order to maximize computational resources. In one example use case, the notification platform 103 would also store place of interest labels (e.g., a restaurant name and location) as long as the information was determined to be valuable given a particular context (e.g., vacation-based POIs may only be stored during the duration of the vacation).

In certain embodiments, once the one or more notifications are stored in the UE 101, the content database 115, or a combination thereof, the notification platform 103 can cause at least one other rendering or view of the one or more notifications, the metadata, the location information, or a combination thereof in the user interface of the UE 101. More specifically, the notification platform 103 can cause one or more renderings of the POI information as part of one or more lists, one or more maps, or a combination thereof (e.g., based on one or more user preferences). Further, the notification platform 103 determines the one or more applicable maps based, at least in part, on the location information associated with the one or more points of interest, the one or more notifications, or a combination thereof. As previously discussed, the notification platform 103 may cause a rendering of a list view in the user interface of the UE 101 identifying the name of the POI in one column (e.g., Coffee Bar) and the details of the associated coupon in an adjacent column (e.g., 2 for 1 coffees) or the POI in one column (e.g., MRT) and the details about the POI in the adjacent column (e.g., Indian Restaurant). In another example use case, the notification platform 103 may cause a rendering of the one or more coupons or the one or more POI labels overlaid on top of one or more maps associated with the geo-coordinates of the POIs.

By way of example, the UE 101, the notification platform 103, the applications 107, the services platform 109, the services 111, the content providers 113, and the satellites 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

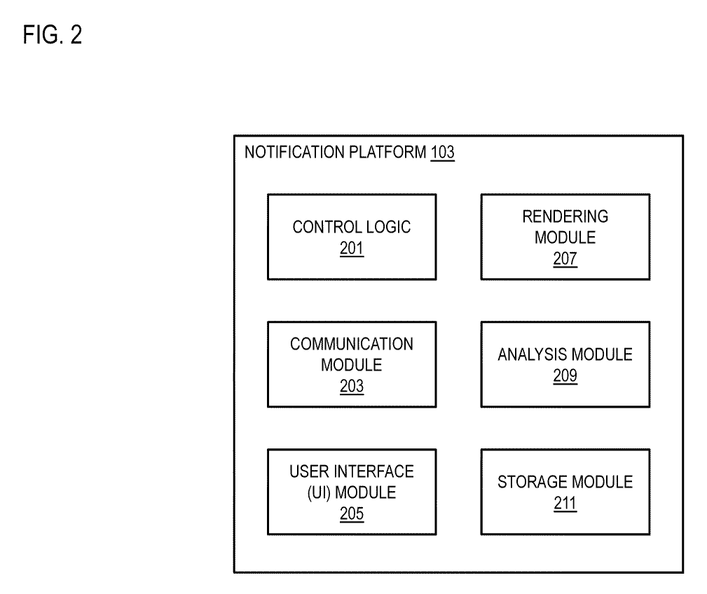

FIG. 2 is a diagram of the components of a notification platform 103, according to one embodiment. By way of example, the notification platform 103 includes one or more components for storing and accessing point of interest information depicted in augmented and/or mixed reality mobile applications. It is contemplated that the functions of these components may be combined in one or more components or performed by other components of equivalent functionality. In this embodiment, the notification platform 103 includes a control logic 201, a communication module 203, a user interface (UI) module 205, a rendering module 207, an analysis module 209, and a storage module 211.

The control logic 201 oversees tasks, including tasks performed by the communication module 203, the user interface (UI) module 205, the rendering module 207, the analysis module 209, and the storage module 211. For example, although the other modules may perform the actual task, the control logic 201 may determine when and how those tasks are performed or otherwise direct the other modules to perform the task.

The communication module 203 is used for communication between the UE 101, the notification platform 103, the applications 107, the services platform 109, the services 111, the content providers 113, and the satellites 117. The communication module 203 may also be used to determine location information (e.g., geo-coordinates) associated with the one or more points of interest in the real-world environment. The communication module 203, in connection with the storage module 211, also may be used to associate the location information with the one or more notifications, the metadata, or a combination thereof associated with the one or more POIs.

The user interface (UI) module 205 is used in connection with the rendering module 207 in order to render a user interface depicting a virtual environment comprising one or more notifications (e.g., one or more coupons, one or more POI labels, geo-tagged content, etc.) associated with one or more POIs (e.g., a clothing store, a coffee shop, a restaurant, etc.). The user interface module 205 may also be used to determine one or more interactions with the user interface of a mobile device (e.g., a mobile phone or tablet), the virtual environment (e.g., an augmented and/or mixed reality application), the one or more notifications (e.g., one or more coupons), or a combination thereof. The user interface module 205 also may be used to capture one or more images, one or more videos, or a combination thereof associated with the virtual environment, the one or more notifications, or a combination thereof based, at least in part, on the one or more interactions. Further, the user interface module 205, in connection with the storage module 211, may also be used to cause, at least in part, a storage of the one or more notifications on the mobile device, one or more remote servers, or a combination thereof.

As previously discussed, the rendering module 207 is used to render a user interface depicting a virtual environment comprising one or more notifications associated with one or more points of interest. More specifically, the rendering module 207, in connection with the communication module 203, may also be used to render the virtual environment, the one or more notifications, or a combination thereof in the user interface based, at least in part, on the location information associated with the one or more points of interest in the real-world environment. The rendering module 207 also may be used to render the one or more notifications, the metadata, the location information, or a combination thereof based, at least in part, on one or more lists, one or maps, or a combination thereof, wherein the one or more maps are based, at least in part, on the location information.

The analysis module 209 is used to process the one or more notifications (e.g., one or more coupons, one or more POI labels, geo-tagged content, etc.) to determine metadata (e.g., coupon details, store information, customer reviews, etc.) associated with the one or more notifications. The analysis module 209 may also be used to process the metadata to determine specific temporal information (e.g., the date of expiration) associated with the metadata.

The storage module 211, in connection with the user interface module 205, is used to manage the storage of the one or more notifications, the metadata, the one or more images, the one or more videos, the location information, or a combination thereof associated with the one or more points of interest at the mobile device (e.g., a mobile phone or tablet) rendering the virtual environment, at one or more remote servers (e.g., based on cloud storage technologies), or a combination thereof. More specifically, the storage module 211 may be used to store the one or more notifications, the one or more images, the one or more videos, or a combination thereof based, at least in part, on the temporal information determined by analysis module 209 from the metadata. By way of example, the storage module 211 may determine to store one or more coupons for their entire period of validation and then potentially overwrite the data in order to maximize computational resources. The storage module 211 may likewise determine to store the one or more POI labels (e.g., a restaurant name and location) as long as the information is determined to be valuable given a particular context (e.g., vacation POIs may only be stored during the duration of the vacation).

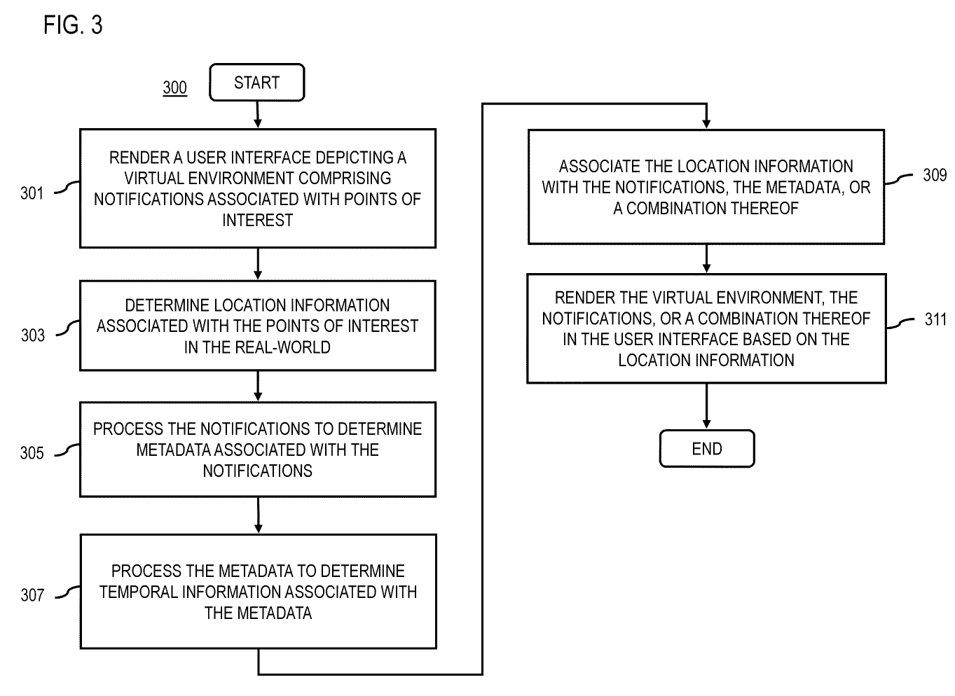

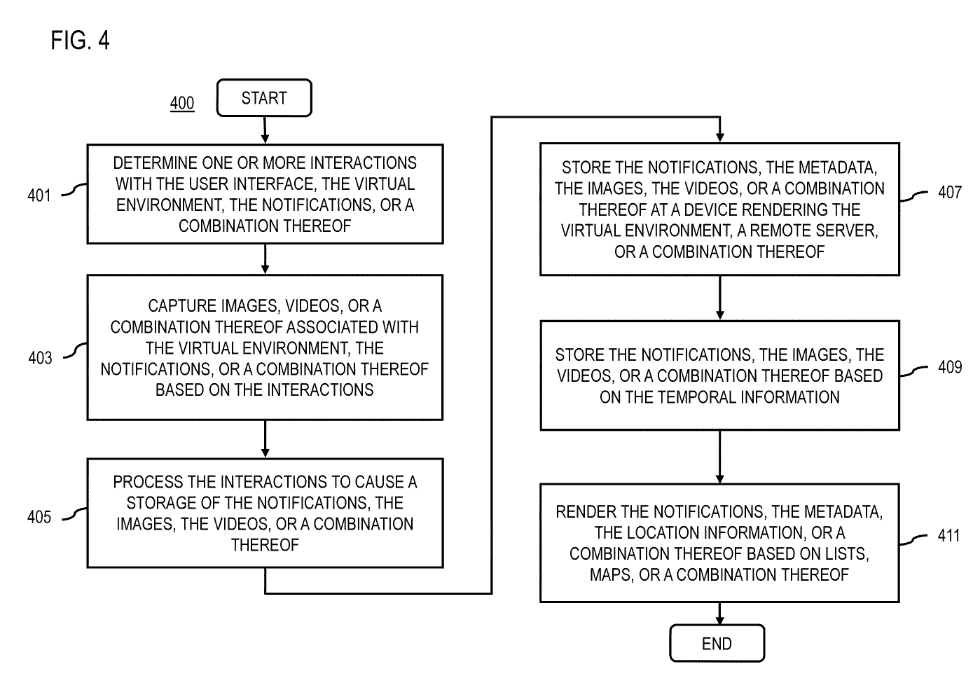

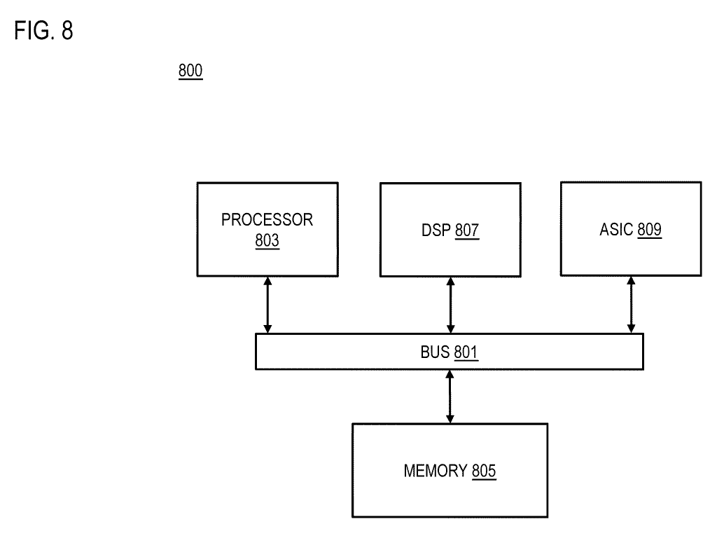

FIGS. 3 and 4 are flowcharts of processes for storing and accessing point of interest information depicted in augmented and/or mixed reality mobile applications, according to one embodiment. FIG. 3 depicts a process 300 of rendering a user interface depicting a virtual environment comprising one or more notifications associated with one or more points of interest. In one embodiment, the notification platform 103 performs the process 300 and is implemented in, for instance, a chip set including a processor and a memory as shown in FIG. 8. In step 301, the notification platform 103 causes, at least in part, a rendering of a user interface depicting a virtual environment comprising one or more notifications associated with one or more points of interest. By way of example, the virtual environment represents, at least in part, a real-world environment and is generated by or is associated with one or more augmented and/or mixed reality applications, one or more point and find technologies, or a combination thereof. In addition, the one or more notifications include one or more coupons (e.g., 20% off clothing, 2 for 1 coffees, etc.), one or more POI labels (e.g., MTR, Sushi Corner, Pizza Hut, etc.), geo-tagged content (e.g., Piazza del Campo), or a combination thereof.

In step 303, the notification platform 103 determines location information associated with the one or more points of interest in the real-world environment. In one example use case, the notification platform 103 determines the location information using one or more location-based technologies associated with a mobile device rendering the virtual environment (e.g., GPS, cellular triangulation, A-GPS, etc.). It is also contemplated that the one or more augmented and/or mixed reality applications used to render the virtual environment on a mobile device may already contain the geo-coordinates for the one or more nearby POIs.

In step 305, the notification platform 103 processes and/or facilitates a processing of the one or more notifications to determine metadata associated with the one or more notifications. By way of example, the metadata may include coupon information (e.g., specific details, the date of expiration, etc.), store information (e.g., hours of operation, contact information, etc.), customer reviews, etc.

In step 307, the notification platform 103 processes and/or facilitates a processing of the metadata to determine temporal information associated with the metadata. In one example use case, the one or more coupons associated with a POI may appear in an augmented and/or mixed reality application of a mobile device (e.g., a mobile phone) for only one week, however, the metadata associated with the coupon states that the offer remains valid for another two weeks after the coupon is no longer visible in the application. Therefore, the one or more coupons may still have value to an end user even after the coupons are no longer visible and should be stored for the duration of the specific offer.

In step 309, the notification platform 103 causes, at least in part, an association of the location information with the one or more notifications, the metadata, or a combination thereof. By way of example, the notification platform 103 associates the location information determined from an augmented and/or mixed reality application, the location-based technologies (e.g., GPS, cellular triangulation, A-GPS, etc.) associated with the mobile device rendering the virtual environment (e.g., a mobile phone or tablet), or a combination thereof in order to more accurately render the virtual environment, the one or more notifications, or a combination thereof in the user interface of the mobile device.

In step 311, the notification platform 103 causes, at least in part, a rendering of the virtual environment, the one or more notifications, or a combination thereof in the user interface based, at least in part, on the location information. As previously discussed, the location information enables the notification platform 103 to accurately render the virtual environment (e.g., an augmented and/or mixed reality application, a mapping or navigation application, etc.) relative to the real-world environment surrounding the mobile device rendering the virtual environment.

FIG. 4 depicts a process 400 of storing and accessing the one or more notifications associated with one or more points of interest. In one embodiment, the notification platform 103 performs the process 400 and is implemented in, for instance, a chip set including a processor and a memory as shown in FIG. 8. In step 401, the notification platform 103 determines one or more interactions with the user interface, the virtual environment, the one or more notification, or a combination thereof. By way of example, the one or more interactions may include an end user clicking the photo capture button of his or her mobile device (e.g., a mobile phone), selecting a “save” button associated with an augmented and/or mixed reality application, tapping the one or more notifications, or a combination thereof. As previously discussed, it is also contemplated that the one or more interactions with the user interface, the virtual environment, the one or more notifications (e.g., one or more coupons), or a combination thereof may simply generate additional information or details associated with the notifications (e.g., metadata) before actually causing a storage of the one or more notifications.

In step 403, the notification platform 103 causes, at least in part, a capture of one or more images, one or more videos, or a combination thereof associated with the virtual environment, the one or more notifications, or a combination thereof based, at least in part, on the one or more interactions. In one example use case, the one or more images, the one or more videos, or a combination thereof are captured in the typical way a mobile device would be used to capture such information. For example, the one or more images may include an image of a shopping plaza, a shopping mall, a particular POI, etc. and the one or more videos may include a video of a drive to work, a drive around town, an exploration of a new area, or a combination thereof.

In step 405, the notification platform 103 processes and/or facilitates a processing of the one or more interactions to cause, at least in part, a storage of the one or more notifications, one or more images, one or more videos, or a combination thereof. By way of example, the one or more notifications, the one or more images, the one or more videos, or a combination thereof may be stored on the mobile device rendering the virtual environment (e.g., in a wallet application), on one or more remote servers (e.g., using cloud storage technologies), or a combination thereof so that the end user may easily review and potentially use the point of interest information at a more convenient time (e.g., when the user is not driving, walking through a crowded street, etc.).

In step 407, the notification platform 103 causes, at least in part, a storage of the one or more notifications, the metadata, the one or more images, the one or more videos, or a combination thereof at a device rendering the virtual environment, at one or more remote servers, or a combination thereof. As previously discussed, the POI information may be stored in a wallet application of the mobile device rendering the virtual environment, at one or more remote servers, or a combination thereof so that an end user is able to later review and potentially use the point of interest information (e.g., one or more coupons, POI labels, geo-tagged content, etc.) at a more convenient time. In addition, in one example use case, access to the one or more remote servers is based, at least in part, on one or more credentials (e.g., a username and password) associated with the mobile device, the one or more end users associated with the device, or a combination thereof.

In step 409, the notification platform 103 causes, at least in part, a storage of the one or more notifications, the one or more images, the one or more videos, or a combination thereof based, at least in part, on the temporal information. By way of example, the one or more notifications (e.g., one or more coupons) may be visibly associated with one or more points of interest for one week, however, the metadata associated with the coupons indicates that the coupons are valid for another two weeks after the coupons are no longer visible. Therefore, the notification platform 103 would store the one or more coupons for their entire period of validation and then potentially overwrite the date in order to maximize computational resources. In another example use case, the notification platform 103 would continue to store the POI information as long as the information was determined to be valuable given a particular context (e.g., vacation-based POIs may only be stored during the duration of the vacation).

In step 411, the notification platform 103 causes, at least in part, at least one other rendering of the one or more notifications, the metadata, the location information, or a combination thereof based, at least in part, on one or more lists, one or more maps, or a combination thereof, wherein the one or more maps are based, at least in part, on the location information associated with the one or more points of interest, the one or more notifications, or a combination thereof. By way of example, the notification platform 103 may render a list view in the user interface of a mobile device identifying the name of the POI in one column (e.g., Coffee Bar) and the details of the associated coupon in an adjacent column (e.g., 2 for 1 coffees) or the name of the POI in one column (e.g., MTR) and the details about the POI in the adjacent column (e.g., Indian food specialty). In another example use case, the notification platform 103 may render one or more coupons or one or more POI labels overlaid on top of one or more maps associated with the geo-coordinates of the POIs. Illustrative examples of the list view and map view user interfaces are depicted in FIGS. 6A and 6B, respectively.

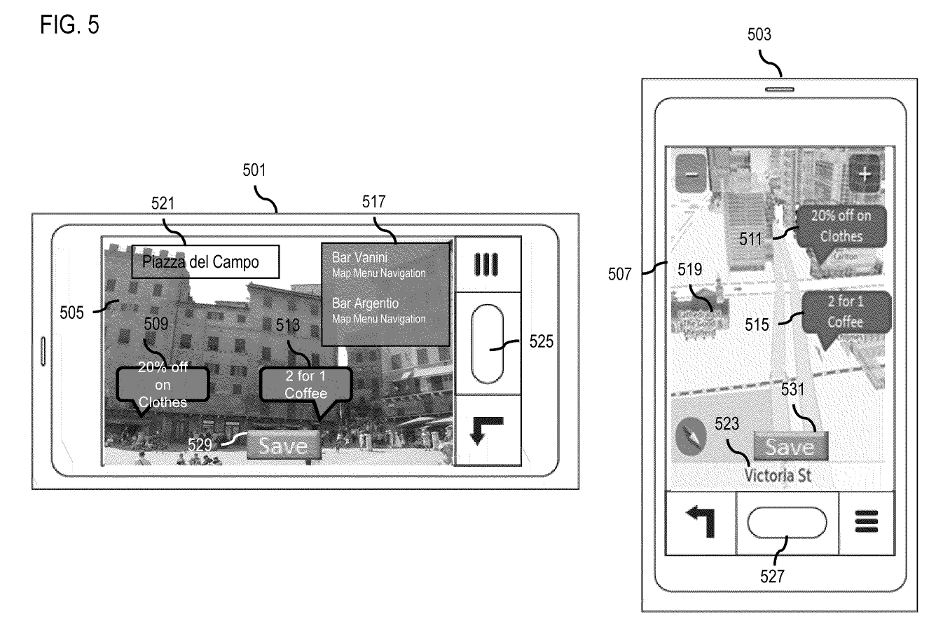

FIGS. 5 through 7 are diagrams of user interfaces utilized in the processes of FIGS. 3 and 4, according to various embodiments. As shown, the example user interfaces of FIGS. 5 through 7 include one or more user interface elements and/or functionalities created and/or modified based, at least in part, on information, data, and/or signals resulting from the processes (e.g., processes 300 and 400) described with respect to FIGS. 3 and 4. More specifically, FIG. 5 illustrates two user interfaces (e.g., interfaces 501 and 503) of the system 100 depicting various embodiments. In one example use case, an end user is exploring a crowded shopping plaza in Italy (e.g., Piazza del Campo) as depicted in the augmented and/or mixed reality application 505 of the user interface 501. In another example use case, an end user is driving to work (e.g., in downtown Singapore) as depicted in the augmented and/or mixed reality application 507 of the user interface 503. In both example use cases, the user interfaces 501 and 503 depict a virtual environment comprising one or more notifications (e.g., coupons 509, 511, 513, and 515, one or more POI labels 517 and 519, geo-tagged content 521 and 523, etc.) associated with one or more points of interest (e.g., a clothing store, a coffee shop, etc.) overlaid on top of the augmented and/or mixed reality applications 505 and 507. As previously discussed, the end user in both example use cases is unable to carefully review or use the point of interest information at the time of discovery (e.g., while walking through a crowded street or driving to work).

In both example use cases, the system 100 first determines location information associated with the one or more points of interest (e.g., the clothing shop associated with coupons 509 and 511 and the coffee shop associated with coupons 513 and 515) proximate to the user interfaces 501 and 503 using one or more location-based technologies associated with the interfaces 501 and 503 (e.g., GPS, cellular triangulation, A-GPS, etc.). As previously discussed, it is contemplated that the location information associated with the nearby POIs may already be contained within the augmented and/or mixed reality applications 505 and 507. The system 100 then process the one or more notifications (e.g., coupons 509, 511, 513, and 515) to determine metadata associated with the one or more notifications (e.g., coupon details, store information, customer reviews, etc.). Further, the system 100 process the metadata to determine specific temporal information (e.g., the date of expiration) associated with the coupons 509, 511, 513, and 515. In one embodiment, the system 100 also associates the location information (e.g., geo-coordinates) with the one or more notifications (e.g., coupons 509, 511, 513, and 515, POI labels 517 and 519, geo-tagged content 521 and 523, etc.) in order to enable a more accurate rendering of the virtual environment as depicted in the augmented and/or mixed reality applications 505 and 507.

In one embodiment, the system 100 next determines one or more interactions with the user interface 501 and 503, the one or more notifications (e.g., coupons 509, 511, 513, and 515), or a combination thereof. By way of example, the one or more interactions may include the end user clicking the photo capture buttons 525 and 527 of the user interfaces 501 and 503, respectively, selecting the “save” button 529 or 531 of the augmented and/or mixed reality applications 505 and 507, respectively, tapping the one or more notifications (e.g., coupons 509, 511, 513, and 515) associated with the augmented and/or mixed reality applications 505 and 507, or a combination thereof. More specifically, the system 100 then causes, at least in part, a capture of one or more images (e.g., of the shopping plaza or the downtown region), one or more videos (e.g., a video of the drive to work), or a combination thereof associated with the virtual environment (e.g., the augmented and/or mixed reality applications 505 and 507), the one or more notifications (e.g., coupons 509, 511, 513, and 515, POI labels 517 and 519, geo-tagged content 521 and 523, etc.), or a combination thereof based, at least in part, on the one or more interactions. As previously discussed, it is also contemplated that in certain embodiments, the system 100 enables one or more interactions with the one or more notifications (e.g., coupons 509, 511, 513, and 515, POI labels 517 and 519, geo-tagged content 521 and 523, etc.) to generate additional information or details associated with the notifications before actually storing the one or more notifications in the system 100 for later review and possible use.

In one embodiment, the system 100 then processes and/or facilitates a processing of the one or more interactions to cause, at least in part, a storage of the one or more notifications (e.g., coupons 509, 511, 513, and 515), the one or more images, the one or more videos, or a combination thereof on the user interfaces 501 and 503 (e.g., in a wallet application). In another embodiment, the system 100 may store the point of interest information at one or more remote servers (e.g., based on cloud storage technologies). As a result, the system 100 enables an end user to review and potentially use the point of interest information at a later and/or more convenient time (e.g., when the user is not walking through a crowded shopping plaza or driving to work).

FIGS. 6A and 6B illustrate user interfaces (e.g., interfaces 601, 603, 631 and 633, respectively) of the system 100 depicting various embodiments. In one embodiment, once the one or more notifications (e.g., one or more coupons) are stored in the system 100 (e.g., in a mobile device, one or more remote servers, or a combination thereof), the system 100 can cause at least one other rendering or view of the one or more notifications, the metadata, the location information, or a combination thereof in the user interfaces of the mobile device (e.g., interfaces 601, 603, 631, and 635). More specifically, the system 100 can render the POI information as part of one or more lists (e.g., interfaces 601 and 603), one or more maps (e.g., interfaces 631 and 635), or a combination thereof (e.g., based on one or more user preferences). In particular, the system 100 determines the one or more applicable maps (e.g., depicted in interfaces 631 and 635) from the location information associated with the one or more points of interest, the one or more notifications, or a combination thereof. By way of example, the system 100 may render a list view in the user interfaces 601 and 603 that identifies the name of the POI in one column (e.g., Dress-Up, Coffee Bar, My Spa) and the details of the associated coupons in the adjacent column (e.g., 20% off on Clothes, 2 for 1 Coffee, 20% off on Spa treatment). In another example case, the system 100 may render a list view of the names of the POIs that an end user has recently seen and wants to remember in one column (e.g., MTR, Sushi Corner, Pizza Hut) and the associated details about each restaurant in the adjacent column (e.g., Indian Restaurant, best Japanese sushi, and Round the clock pizza).

The processes described herein for storing and accessing point of interest information depicted in augmented and/or mixed reality mobile applications may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

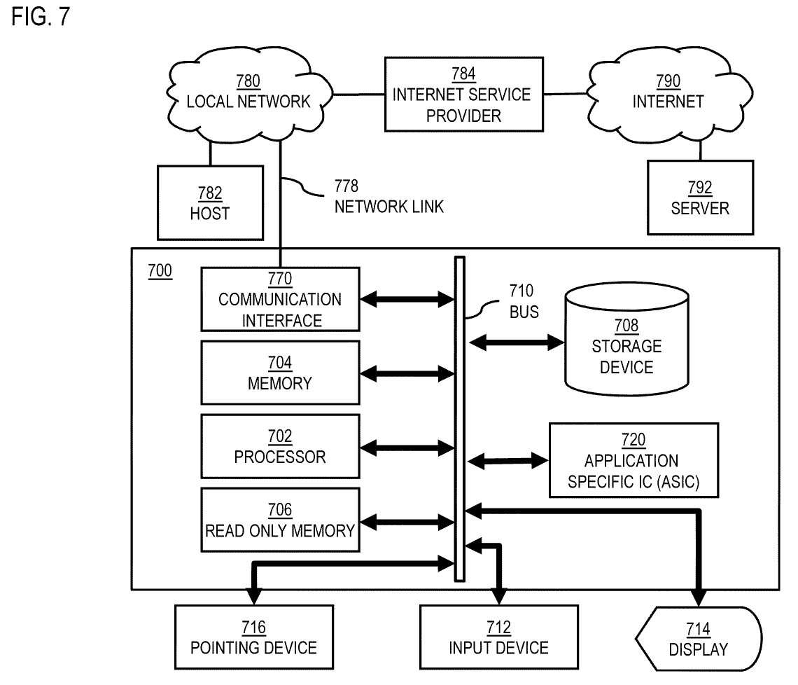

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to store and access point of interest information depicted in augmented and/or mixed reality mobile applications as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of storing and accessing point of interest information depicted in augmented and/or mixed reality mobile applications.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to store and access point of interest information depicted in augmented and/or mixed reality mobile applications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for storing and accessing point of interest information depicted in augmented and/or mixed reality mobile applications. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for storing and accessing point of interest information depicted in augmented and/or mixed reality mobile applications, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for storing and accessing point of interest information depicted in augmented and/or mixed reality mobile applications associated with the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to store and access point of interest information depicted in augmented and/or mixed reality mobile applications as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of storing and accessing point of interest information depicted in augmented and/or mixed reality mobile applications.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to store and access point of interest information depicted in augmented and/or mixed reality mobile applications. The memory 805 also stores the data associated with or generated by the execution of the inventive steps.

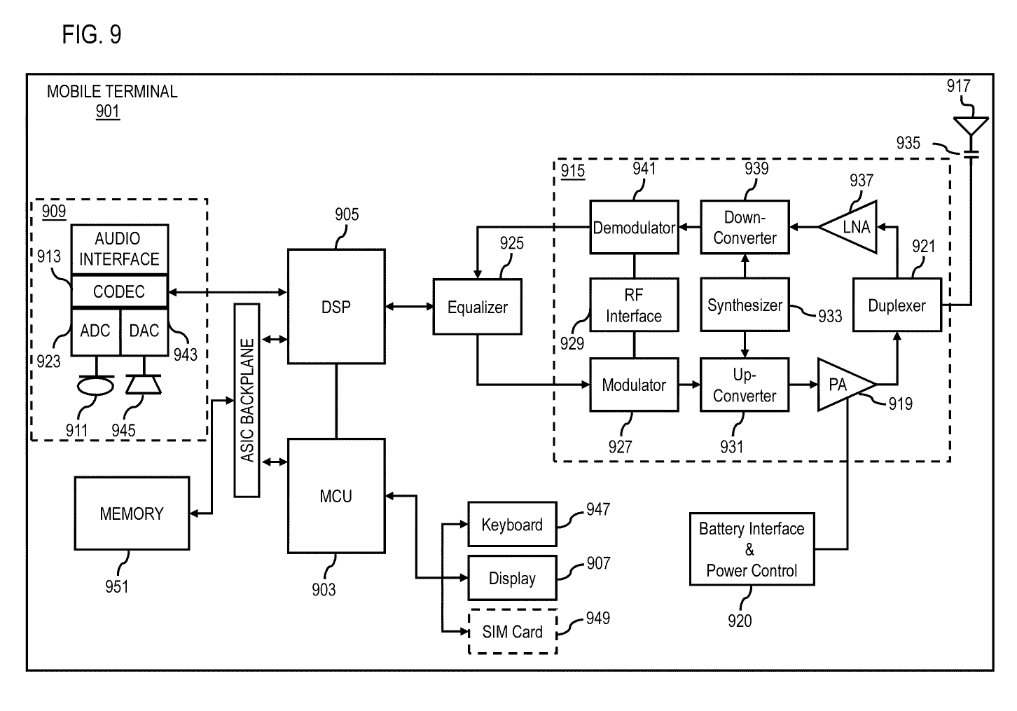

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of storing and accessing point of interest information depicted in augmented and/or mixed reality mobile applications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of storing and accessing point of interest information depicted in augmented and/or mixed reality mobile applications. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up- converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to store and access point of interest information depicted in augmented and/or mixed reality mobile applications. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a rendering of a user interface depicting a virtual environment comprising one or more notifications associated with one or more points of interest;
at least one determination of one or more interactions with the user interface, the virtual environment, the one or more notification, or a combination thereof; and
a processing of the one or more interactions to cause, at least in part, a storage of the one or more notifications, one or more images, one or more videos, or a combination thereof.

2. A method of claim 1, wherein the one or more notifications include, at least in part, one or more coupons, one or more point-of-interest labels, geo-tagged content, or a combination thereof.

3. A method of claim 1, wherein the (1) data and/or (2) information and/or (3) at least one signal are further based, at least in part, on the following:
a capture of one or more images, one or more videos, or a combination thereof associated with the virtual environment, the one or more notifications, or a combination thereof based, at least in part, on the one or more interactions.

4. A method of claim 2, wherein the (1) data and/or (2) information and/or (3) at least one signal are further based, at least in part, on the following:
a processing of the one or more notifications to determine metadata associated with the one or more notifications.

5. A method of claim 4, wherein the (1) data and/or (2) information and/or (3) at least one signal are further based, at least in part, on the following:
a processing of the metadata to determine temporal information associated with the metadata; and
a storage of the one or more notifications, the one or more images, the one or more videos, or a combination thereof based, at least in part, on the temporal information.

6. A method of claim 1, wherein the virtual environment represents, at least in part, a real-world environment, wherein the (1) data and/or (2) information and/or (3) at least one signal are further based, at least in part, on the following:
at least one determination of location information associated with the one or more points of interest in the real-world environment; and
a rendering of the virtual environment, the one or more notifications, or a combination thereof in the user interface based, at least in part, on the location information.

7. A method of claim 6, wherein the (1) data and/or (2) information and/or (3) at least one signal are further based, at least in part, on the following:
an association of the location information with the one or more notifications, the metadata, or a combination thereof.

8. A method of claim 1, wherein the (1) data and/or (2) information and/or (3) at least one signal are further based, at least in part, on the following:
at least one other rendering of the one or more notifications, the metadata, the location information, or a combination thereof based, at least in part, on one or more lists, one or more maps, or a combination thereof,
wherein the one or more maps are based, at least in part, on the location information associated with the one or more points of interest, the one or more notifications, or a combination thereof.

9. A method of claim 1, wherein the (1) data and/or (2) information and/or (3) at least one signal are further based, at least in part, on the following:
a storage of the one or more notifications, the metadata, the one or more images, the one or more videos, or a combination thereof at a device rendering the virtual environment, at one or more remote servers, or a combination thereof.

10. A method of claim 9, wherein access to the one or more servers is based, at least in part, on one or more credentials associated with the device, an end user associated with the device, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a rendering of a user interface depicting a virtual environment comprising one or more notifications associated with one or more points of interest;
determine one or more interactions with the user interface, the virtual environment, the one or more notification, or a combination thereof; and
process and/or facilitate a processing of the one or more interactions to cause, at least in part, a storage of the one or more notifications, one or more images, one or more videos, or a combination thereof.

12. An apparatus of claim 11, wherein the one or more notifications include, at least in part, one or more coupons, one or more point-of-interest labels, geo-tagged content, or a combination thereof.

13. An apparatus of claim 11, wherein the apparatus is further caused to:
cause, at least in part, a capture of one or more images, one or more videos, or a combination thereof associated with the virtual environment, the one or more notifications, or a combination thereof based, at least in part, on the one or more interactions.

14. An apparatus of claim 12, wherein the apparatus is further caused to:
process and/or facilitate a processing of the one or more notifications to determine metadata associated with the one or more notifications.

15. An apparatus of claim 14, wherein the apparatus is further caused to:
process and/or facilitate a processing of the metadata to determine temporal information associated with the metadata; and
cause, at least in part, a storage of the one or more notifications, the one or more images, the one or more videos, or a combination thereof based, at least in part, on the temporal information.

16. An apparatus of claim 11, wherein the virtual environment represents, at least in part, a real-world environment, wherein the apparatus is further caused to:
determine location information associated with the one or more points of interest in the real-world environment; and
cause, at least in part, a rendering of the virtual environment, the one or more notifications, or a combination thereof in the user interface based, at least in part, on the location information.

17. An apparatus of claim 16, wherein the apparatus is further caused to:
cause, at least in part, an association of the location information with the one or more notifications, the metadata, or a combination thereof.

18. An apparatus of claim 11, wherein the apparatus is further caused to:
cause, at least in part, at least one other rendering of the one or more notifications, the metadata, the location information, or a combination thereof based, at least in part, on one or more lists, one or more maps, or a combination thereof,
wherein the one or more maps are based, at least in part, on the location information associated with the one or more points of interest, the one or more notifications, or a combination thereof.

19. An apparatus of claim 11, wherein the apparatus is further caused to:
cause, at least in part, a storage of the one or more notifications, the metadata, the one or more images, the one or more videos, or a combination thereof at a device rendering the virtual environment, at one or more remote servers, or a combination thereof.

20. An apparatus of claim 19, wherein access to the one or more servers is based, at least in part, on one or more credentials associated with the device, an end user associated with the device, or a combination thereof.

21-48. (canceled)
